(19) United States
(12) Patent Application Publication
(10) Pub. No.: US 2026/0277849 A1
(43) Pub. Date: Sep. 17, 2026

(54) METHOD AND SYSTEM FOR PROVIDING A COMMUNICATION BUS WITHIN A PORTABLE COMPUTING DEVICE (PCD) THAT SUPPORTS A LOW POWER MODE

(71) Applicant: Qualcomm Incorporated, San Diego, CA (US)

(72) Inventors: Christopher Todd BOYD, Fuquay Varina, NC (US); Burcin Serter ERGUN, Poway, CA (US); Julian PUSCAR, Holly Springs, NC (US)

(21) Appl. No.: 19/082,034

(22) Filed: Mar. 17, 2025

(51) Int. Cl. G06F 13/42; G06F 1/324

(52) U.S. Cl. CPC G06F 13/4291; G06F 1/324; G06F 2213/0026

(57) ABSTRACT

A method and system for managing a bus system within a portable computing device (PCD) during a low power mode includes powering the bus system with a limited portable power supply. The method may further include receiving a first signal indicating that one or more endpoints of the bus system are entering into a low power mode. The method may also include receiving a second signal indicating how many communication links that will be supported by the bus system during the low power mode. And the method may include determining if a clock coupled to a transmission line of the bus system should function as a clock during the low power mode or if the clock should function as a clock driver during the low power mode. When a clock functions as a clock driver, then one or more elements of the clock may be turned-off/shut-off.

### DESCRIPTION OF THE RELATED ART

A computing device may include multiple processor-based subsystems. A computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications.

PCDs are often powered by a limited power supply, such as, but not limited to, rechargeable batteries. Because of their limited power supply and when not “plugged-in” or coupled to an alternating current (“A/C”) power supply, PCDs often support low power modes (“LPMs”) to conserve the life/longevity of the limited power supply. During LPMs and in order to conserve power, a PCD may shut down several hardware and/or software components or place them in a low powered state where these components do not provide any functionality during this low powered state.

One problem with conventional PCDs is that communication buses between processors/components within a PCD often do not support LPMs. Processors that exist on a single chip (i.e. such as a System on Chip (“SoC”)) and/or on the same printed circuit board (“PCB”) may be coupled to each other by a common bus. This common bus may transmit its signals according to one or more standards, such as the peripheral component interconnect express (“PCIe”).

It would be desirable if PCDs which employ PCIe communication buses between hardware components and/or software components can support one or more LPMs in order to conserve power when the PCD is powered by a limited power supply (i.e. rechargeable batteries).

### SUMMARY OF THE DISCLOSURE

Systems, methods and other examples are disclosed for managing a bus system within a portable computing device (PCD) during a low power mode where one or more clocks are controlled to conserve power.

A method for managing a bus system within a PCD during a low power mode includes powering the bus system with a limited portable power supply. The method may further include receiving a first signal indicating that one or more endpoints of the bus system are entering into a low power mode. The method may also include receiving a second signal indicating how many communication links that will be supported by the bus system during the low power mode.

And the method may include determining if a clock coupled to a transmission line of the bus system should function as a clock during the low power mode or if the clock should function as a clock driver during the low power mode. When a clock is determined to function as a clock driver, then the method may include turning/shutting off: at least one of a voltage controlled oscillator, a clock driver, and slew control, for the clock.

A system for managing a bus system within a PCD during a low power mode may include a limited portable power supply for powering the bus system and a physical coding sublayer (PCS) control module receiving a first signal indicating that one or more endpoints of the bus system are entering into a low power mode. The PCS control module may receive a second signal indicating how many communication links that will be supported by the bus system during the low power mode.

The PCS control module may determine if a clock coupled to a transmission line of the bus system should function as a clock during the low power mode or if the clock should function as a clock driver during the low power mode. When a clock is determined to function as a clock driver, then the PCS control module turns off at least one of: a voltage controlled oscillator, a clock driver, and slew control, for the clock.

A computer program product may include a non-transitory computer usable medium having a computer readable program code embodied therein, where the computer readable program code is adapted to be executed to implement a method for managing a bus system. The method executed by the code may include powering the bus system with a limited portable power supply and receiving a first signal indicating that one or more endpoints of the bus system are entering into a low power mode.

The method executed by the code may further include receiving a second signal indicating how many communication links that will be supported by the bus system during the low power mode, and determining if a clock coupled to a transmission line of the bus system should function as a clock during the low power mode or if the clock should function as a clock driver during the low power mode.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1A illustrates a high-level functional block diagram of a bus system having a single row layout that supports a single communication link 103A that may operate according to the peripheral component interconnect express (“PCIe”) serial computer expansion bus standard;

FIG. 1B illustrates a high-level functional block diagram of a bus system having a two row layout that supports a single communication link 103B that may operate according to the PCIe serial computer expansion bus standard;

FIG. 1C illustrates a high-level functional block diagram of a bus system having a single row layout that supports two communication links 103A1, 103A2 that may operate according to the PCIe serial computer expansion bus standard;

FIG. 1D illustrates a high-level functional block diagram of a bus system having a two row layout that supports two communication links 103B1, 103B2 that may operate according to the PCIe serial computer expansion bus standard;

FIG. 2A is a functional block diagram illustrating the details for the single row layout of FIG. 1A that supports a single communication link that may operate according to the peripheral component interconnect express (“PCIe”) serial computer expansion bus standard;

FIG. 2B is a functional block diagram illustrating the details for the single row layout of FIG. 1A, according to different exemplary embodiment relative to FIG. 2A, that supports a single communication link that may operate according to the peripheral component interconnect express (“PCIe”) serial computer expansion bus standard;

FIG. 2C is a functional block diagram illustrating the details for the two row layout of FIG. 1B that supports a single communication link according to one exemplary embodiment;

FIG. 3A is a functional block diagram illustrating the details for the single row layout of FIG. 1C in which two communication links 103A1, 103A2 are supplied between end points of the bus system according to one exemplary embodiment;

FIG. 3B is a functional block diagram illustrating the details for the two row layout of FIG. 1D that supports two communication links 103B1, 103B2 according to one exemplary embodiment;

FIG. 3C is a functional block diagram illustrating the details for the two row layout of FIG. 1D that supports two communication links 103B1, 103B2 according to an alternative exemplary embodiment compared to FIG. 3B;

FIG. 4 illustrates a logical flow chart of a method for managing a communication bus system in a portable computing device (PCD) during a low power mode (LPM); and

FIG. 5 illustrates details of an exemplary portable computing device (PCD) that houses the limited portable power supply and SoC/PCB 102 illustrated in FIG. 1A and which can support low power modes of its communication buses positioned on/within each SoC/PCB 102.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

The terms “logic” and/or “module,” as those terms are used in this disclosure, may denote or describe digital circuits, such as digital gate structures, that are combined and configured in a particular manner to achieve one or more particular functions. For example, a control logic and/or a control module may include a combination of digital circuits that have been combined and configured in a particular manner to achieve one or more particular control functions. Control logic and/or a control module may be embodied only/solely in hardware; only/solely in software; or in a combination of hardware, software and/or firmware.

The terms “circuit” or “circuitry” as those terms are used herein, denotes electrical circuitry comprising discrete analog, and/or digital, and/or discrete circuit elements/hardware components.

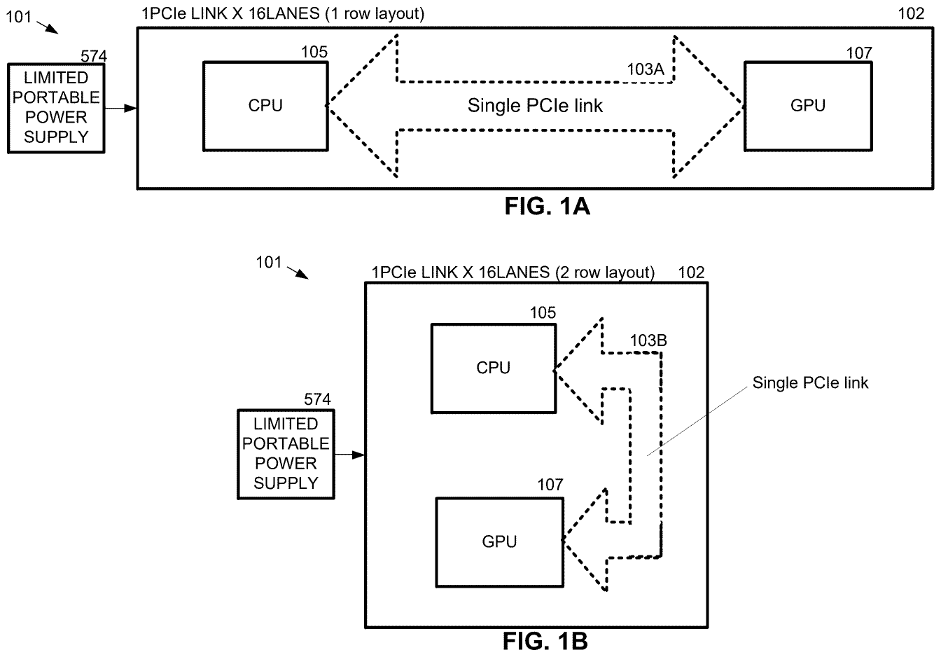

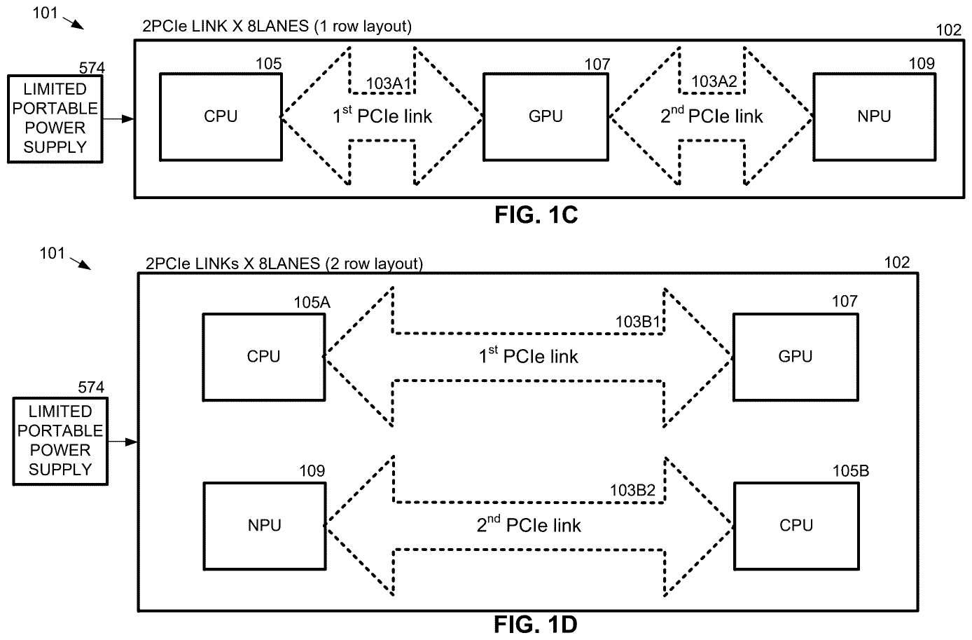

Referring now to FIG. 1A, this figure is a high-level functional block diagram of a bus system 101 having a single row layout that supports a single communication link 103A that may operate according to the peripheral component interconnect express (“PCIe”) serial computer expansion bus standard. As shown in FIG. 1A, the bus system 101 may support a single PCIe communication link 103A between two processors 105, 107 physically arranged in a single row on a System-on-Chip (“SoC”) or Printed Circuit Board (“PCB”) 102.

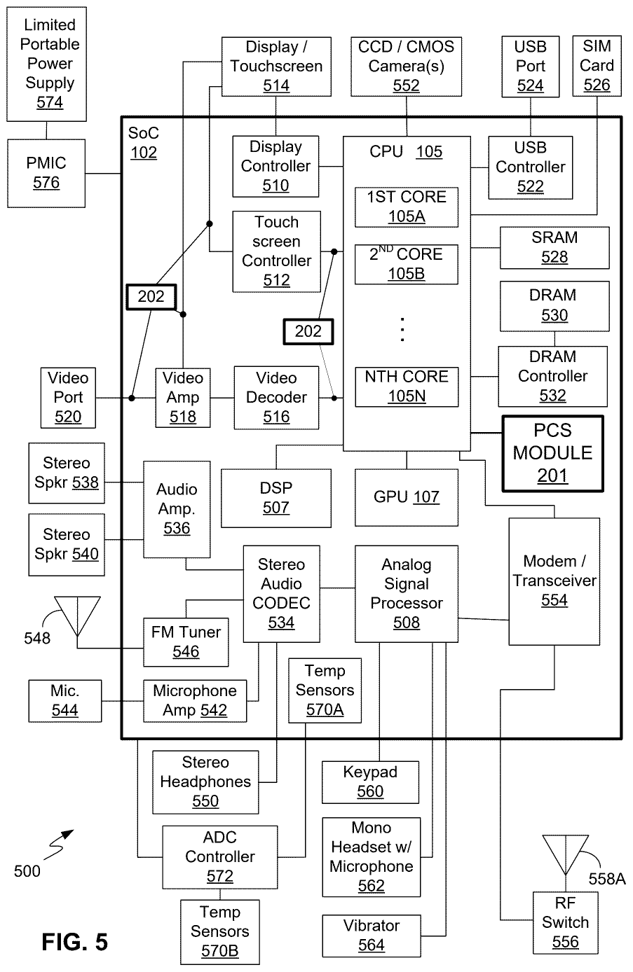

According to the exemplary embodiment illustrated in FIG. 1A, a first processor 105 may comprise a central processing unit (“CPU”) while a second processor 107 may comprise a graphics processing unit (“GPU”). The SoC/PCB 102 that supports the CPU 105, GPU 107, and bus system 101 may be housed within a PCD 500 (see FIG. 5). The SoC/PCB 102 may be coupled to a limited portable power supply 574 (see also FIG. 5).

The limited portable power supply 574 may comprise one or more rechargeable batteries that provide direct current (“DC”) power. However, the limited portable power supply 574 may also include capacitors, and/or rechargeable batteries combined with capacitors as understood by one of ordinary skill in the art. The PCD 500 and its technical details are further described below in connection with FIG. 5.

As understood by one of ordinary skill in the art, the PCIe serial computer expansion bus standard is used in most electronic devices, which includes, but are not limited to, graphics cards, sound cards, mobile devices, devices that use the WI-FI(TM) IEE 802.11x wireless communication standard, ethernet, and many other hardware connections.

The bus system 101 having the single row layout in FIG. 1A may support and use PCIe for its communications among its endpoints 105, 107 within the bus system 101 that is present within the PCD 500. The bus system 101, operating according to the PCIe standard, may adjust its bus speed or bus clock frequency upwards and/or downwards for the single communication link 103A depending on various conditions as understood by one of ordinary skill in the art.

Different generations (“Gen”)/versions of the bus system 101 may support a range of bus speeds: a Gen 1 of the bus system 101 may operate at about a 1.25 GHz clock frequency/(2.5 Gigabits per second—“Gbps”) speed (and may be characterized as a lowest speed—“L0”); a Gen 2 of the bus system 101 may operate at about a 2.50 GHz clock frequency/(5.0 Gbps) speed (and may be characterized as an intermediate speed “L1”); and a Gen 3 of the bus system 101 may operate at about a 4.0 GHz clock frequency/ (8 Gbps) speed (and may be characterized as an intermediate speed—“L2”).

Similarly, a Gen 4 of the bus system 101 may operate at about a 8.0 GHz clock frequency/(16 Gbps) speed (and may be characterized as an intermediate speed—“L3”); a Gen 5 of the bus system 101 may operate at about a 16.0 GHz clock frequency/(32 Gbps) speed (and may be characterized as an intermediate speed—“L4”); and a Gen6 of the bus system 101 may operate at about a 32.0 GHz clock frequency/(64 Gbps) speed (and may be characterized as a highest speed—“L5”). However, other clock speeds, additional clock speeds (i.e. Gen7 & greater), and other ranges of clock speeds (i.e. future higher speeds) are possible and are included within the scope of this disclosure.

The bus system 101 may increase and/or decrease its bus speed (i.e. the bus clock frequency) following the Gen speeds noted above (i.e. from Gen1 to Gen2, from Gen2 to Gen3 etc.) when the system 101 detects that one or more of its endpoints 105, 107 (i.e. such as first processor and second processors 105, 107) may support the higher or lower Gen bus speeds.

That is, each end point 105, 107 may not support all Gen speeds. Some end points 105, 107 may have been manufactured and designed for older and lower Gen speeds as understood by one of ordinary skill in the art. Other types as well as a different number of endpoints 105, 107 (i.e. processor types and number) may be coupled to the communication link 103A without departing from the scope of this disclosure.

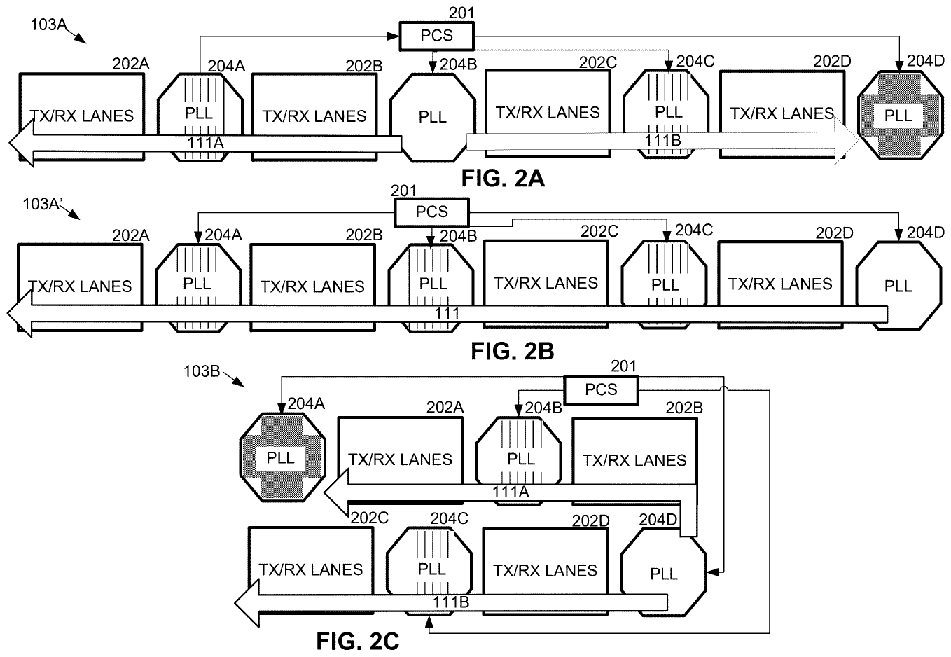

To support these different Gen bus speeds, transmission and receiver lanes 202 (not shown in FIG. 1A-1B, but see FIGS. 2A-4B) of the bus system 101 need clock signals produced by clocks 204 (see FIGS. 2A-2B) to support the Gen bus speeds noted above. According to the exemplary embodiment illustrated in FIG. 1A, the bus system 101 may comprise sixteen communication lanes 202, where there are eight (8) transmission lanes and eight (8) receiver lanes to support duplex communications between end points 105, 107.

These communication lanes 202 (see FIGS. 2A-2B) may support a low power mode in order to conserve energy for the limited portable power supply 574 that is coupled to the SoC/PCB 102. Further details of how the communication lanes 202 of the bus system 101 of FIG. 1A supports a low power mode will be described in connection with FIGS. 2A-2B.

While the bus system 101 may support the PCIe serial computer expansion bus standard as noted above, the system 101 may support other known standards and/or other standards that may be developed in the future. That is, the system 101 of this disclosure may support any other Serializer-Deserializer link interfaces as understood by one of ordinary skill in the art.

Referring now to FIG. 1B, this figure illustrates a high-level functional block diagram of a bus system 101 having a two row layout that supports a single communication link 103B across two rows that may operate according to the peripheral component interconnect express (“PCIe”) serial computer expansion bus standard. FIG. 1B is similar to FIG. 1A, so only the differences will be described in detail here.

The CPU 105 of FIG. 1B may be positioned in a first row relative to the SoC/PCB 102. Meanwhile, the GPU 107 may be positioned in a second row relative to the SoC/PCB 102. The bus system 101 may have transmission and receiver lanes 202 (see FIG. 2C) that provide physical connections between the two rows shown in FIG. 1B and which support the single communication link 103B.

The bus system 101 of FIG. 1B having the two row layout may comprise sixteen communication lanes 202 (see FIG. 2C) where there are eight (8) transmission lanes and eight (8) receiver lanes to support duplex communications between end points 105, 107. The bus system 101 of FIG. 1B, like the bus system 101 of FIG. 1A, may support any number of different Gen speeds described above as well as supporting a low power mode, where the Gen speeds may be available during the low power mode for each communication link 103A, 103B.

Other types as well as a different number of endpoints 105, 107 (i.e. processor types, memory devices, and number) may be coupled to the communication link 103B without departing from the scope of this disclosure. Further details of how the communication lanes 202 (see FIG. 2C) of the bus system 101 of FIG. 1B having a two row layout supports a low power mode and a single communication link 103B between the two rows will be described in connection with FIG. 2C.

Referring now to FIG. 1C, this figure illustrates a high-level functional block diagram of a bus system 101 having a single row layout that supports two communication links 103A1, 103A2 that may operate according to the peripheral component interconnect express (“PCIe”) serial computer expansion bus standard. FIG. 1C is similar to FIG. 1A, so only the differences will be described in detail here.

The CPU 105, GPU 107, an NPU 109 of FIG. 1C may be positioned in a single row relative to the SoC/PCB 102. A first communication link 103A1 may be provided between the CPU 105 and the GPU 107. Similarly, a second communication link 103A2 may be provided between the GPU 107 and the NPU 109.

Each of the two communication links 103A1, 103A2 of FIG. 1C may operate according to the PCIe standard described above. The system 101 is not limited to the hardware 105, 107, 109 illustrated in FIG. 1C that form the end points of the two communication links 103A1, 103A2 of the single row layout. Other types as well as a different number of endpoints 105, 107, 109 (i.e. processor types and number) may be coupled to the two communication links 103A1, 103A2 without departing from the scope of this disclosure.

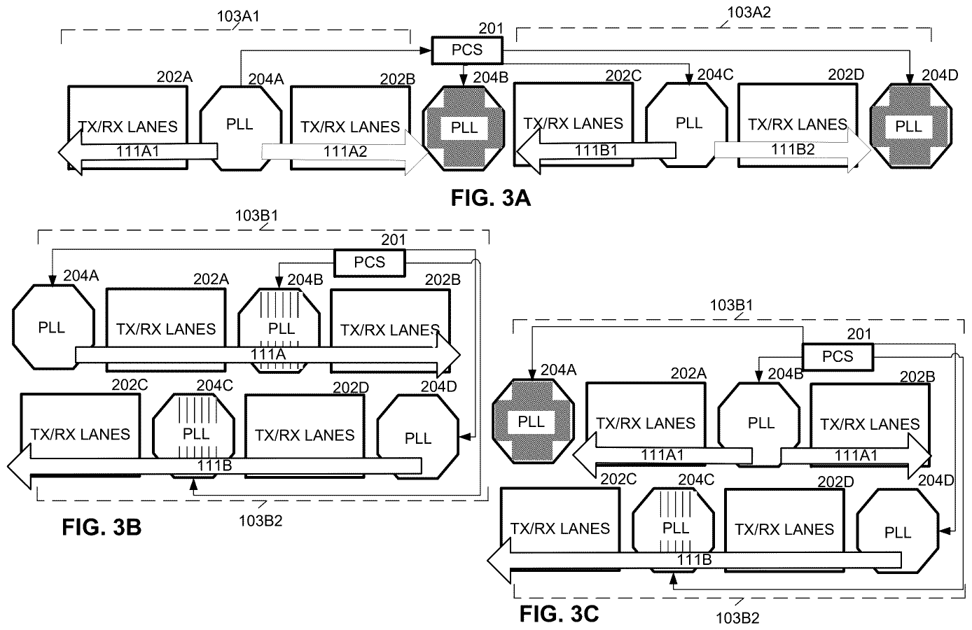

Each communication link 103A1, 103A2 provided in the single row layout of FIG. 1C may comprise eight communication lanes 202 (see FIG. 3A) where there are four (4) transmission lanes and four (4) receiver lanes to support duplex communications between end points 105, 107, 109. The bus system 101 of FIG. 1C, like the bus systems 101 of FIGS. 1A-1B, may support any number of different Gen speeds described above as well as supporting a low power mode. Further details of how the communication lanes 202 (see FIG. 3A) of the bus system 101 of FIG. 1C having a single row layout supports a low power mode and two communication links 103A1, 103A2 will be described in connection with FIG. 3A.

Referring now to FIG. 1D, this figure illustrates a high-level functional block diagram of a bus system 101 having a two row layout that supports two communication links 103B1, 103B2 that may operate according to the peripheral component interconnect express (“PCIe”) serial computer expansion bus standard. FIG. 1D is similar to FIG. 1C, so only the differences will be described in detail here.

A first CPU 105A and a GPU 107 and a first communication link 103B1 may be positioned in a first row relative to the SoC/PCB 102. Similarly, an NPU 109 and a second CPU 105B and a second communication link 103B2 may be positioned in a second row relative to the SoC/PCB 102 and relative to the first row described above.

Each of the two communication links 103B1, 103B2 of FIG. 1D may operate according to the PCIe standard described above. The system 101 is not limited to the hardware 105A, 105B, 107, 109 illustrated in FIG. 1D that form the end points of the two communication links 103B1, 103B2 of the two row layout. Other types as well as a different number of endpoints (i.e. processor types and number) may be coupled to each communication link 103B1, 103B2 without departing from the scope of this disclosure.

Each communication link 103 of the two links 103B1, 103B2 provided in this two row layout of FIG. 1C may comprise eight communication lanes 202 (see FIGS. 3B-3C) where there are four (4) transmission lanes and four (4) receiver lanes to support duplex communications between end points 105A, 105B, 107, 109. The bus system 101 of FIG. 1D, like the bus systems 101 of FIGS. 1A-1C, may support any number of different Gen speeds described above as well as supporting a low power mode.

Further details of how the communication lanes 202 of the bus system 101 of FIG. 1D having a two row layout and two communication links 103B1, 103B2 supports a low power mode will be described in connection with FIGS. 3B-3C.

Referring now to FIG. 2A, this figure is a functional block diagram of the details for the single row layout of FIG. 1A that supports a single communication link 103A that may operate according to the peripheral component interconnect express (“PCIe”) serial computer expansion bus standard. The single row layout of the bus system 101 of FIG. 2A may comprise four sets of transmission (TX) & receiving (RX) lines 202A, 202B, 202C, & 202D, where each TX/RX block 202 contains a total of four lanes (i.e. two for transmission & two for reception).

Positioned to the right side of each TX/RX block 202 is a clock 204. Each clock 204 may comprise a phase-locked-loop (PLL) type of clock as understood by one of ordinary skill in the art. However, other types of clocks are possible and are included within the scope of this disclosure. Other clock types include, but are not limited to, crystal oscillators, delay-locked loops (DLLs), and frequency-locked loops (FLLs), just to name a few.

PLL clocks 204 are preferred in order to support communication links propagating across the TX/RX blocks 202 according to the PCIe standard. Each PLL clock 204 may support any Gen speed of the PCIe standard noted above (which includes, at least, Gen1 thru Gen6 speeds).

Each PLL clock 204 may be coupled the physical coding sublayer (PCS) control module 201. The PCS control module 201 resides at the top of the physical layer (PHY) according to the PCIe standard, and it may provide an interface between the physical medium attachment (PMA) sublayer and the media-independent interface (MII). The PCS control module 201 is typically responsible for data encoding and decoding, scrambling and descrambling, alignment marker insertion and removal, block and symbol redistribution, and lane block synchronization and deskew as understood by one of ordinary skill in the art.

According to one feature of the inventive bus system 101 illustrated in FIGS. 2A-4B, the PCS control module 201 may be programmed to support a low power mode of operation. During this low power mode of operation, each clock 204 the bus system 101 may be placed into one of three low power modes that will be described in detail below.

A first low power mode may include shutting off power (or reducing power significantly) to a clock 204 such that it does not support any communication signals and/or does not operate. This first low power mode of a clock 204 may consume the least power from the limited portable power supply 574 (see FIG. 1A).

A second low power mode may include reducing power consumption of a clock 204 by turning off its voltage controlled oscillator (VCO) that is present in most PLL clocks 204. The second low power mode may further include shutting off one or more clock drivers used by a clock 204. And the second low power mode may further include shutting off slew control (i.e. when the clock 204 is a PLL clock 204). This second low power mode is an intermediate state between the first power mode and a third power mode. The second low power mode consumes less power than the first power mode but more power than the third power mode, described below.

While in this second low power mode, a clock 204 may still support communication signals. And when supporting communication signals, any clock 204 in this second low power mode basically functions as a clock driver as understood by one of ordinary skill in the art.

In other words, the clock 204 in this second low power mode is used as a re-driver or extension of the clock network instead of functioning as a “regular” or “standard” clock. This means the PLL clock 204 in the second low power mode does not originate or generate any clock signals but instead relays or transmits clock signals that it receives from another clock.

A third low power mode may include a clock 204 to function as a primary or single clock for a single communication link that may operate according to the PCIe standard. That is, in this third low power mode for the bus system 101, a clock 204 may operate as a single active clock 204 that supports only one communication link 103 between two end points (i.e. 105, 107 of FIG. 1A) and includes supporting any Gen bus speed noted previously.

Referring back to FIG. 2A which illustrates a single row layout of a single communication link 103A, when the PCS control module 201 receives a signal that one or more of its end points 105, 107 (see FIG. 1A) may be entering into a low power mode. During this low power mode (LPM), since only one communication link 103A may be needed, the PCS control module 201 may send a signal to the first PLL clock 204A and the third PLL clock 204C to put these two clocks 204 into the second low power mode described previously.

In this second low power mode, each clock 204A, 204C of FIG. 2A may function as clock driver and will not have its voltage controlled oscillator (VCO) powered (i.e. turned on). The first PLL clock 204A and the third PLL clock 204C have been illustrated with vertical lines to denote this second low power mode.

The PCS control module 201 may then send a signal to the second PLL clock 204B of FIG. 2A to place it into the third low power mode described above such that second PLL clock 204B functions as the primary/sole/single clock for the communications link during the low power mode. The second PLL clock 204B has not been provided with any shading (i.e. it is clear compared to clocks 204A, 204C, & 204D) to denote that it is operating in this third low power mode described above.

The PCS control module 201 may also send a signal to the fourth PLL clock 204D of FIG. 2A to place this clock 204D into the first low power mode described previously. In this first low power mode, the fourth PLL clock 204D may not receive any power or a negligible power amount such that it does not support any communication signals and/or does not operate. The fourth PLL clock 204D has been shaded with gray shading to indicate that it is in the first low power mode as described previously.

With the second PLL clock 204B of FIG. 2A operating in the third low power mode, where this clock 204B is functioning “normally” to support any one of the Gen speeds noted above, two arrows 111A, 111B originating from the second PLL clock 204B represents the clock signal of the second PLL clock 204B. The arrows 111A, 111B indicate that the second PLL clock 204B is the primary clock 204 for establishing/generating the clock signal which supports the single communication link 103A (see also FIG. 1A) supported by the TX/RX lanes 202A-202D and the three PLL clocks 204A, 204C, 204D. In other words, the PLL clock 204B supplies its clock signals for each of the four TX/RX lanes 202A-202D which support the single communication link 103A, which may operate according to the PCIe standard discussed above.

The single communication link 103A allows for communications between the end points 105, 107 (not shown in FIG. 2A, but see FIG. 1A). Thus, the PLL clock 204B functions as the primary/single/sole clock for communication link 103A as indicated by arrows 111A, 111B while the first PLL clock 204A and third PLL clock 204C function as clock drivers (i.e. re-transmitters/repeaters) for the clock signals received from the second PLL clock 204B.

Meanwhile, the fourth PLL clock 204D of FIG. 2A in the first low power mode does not support any communication signals 105. However, the fourth PLL clock 204D consumes the least power compared to the first, second, and third PLL clocks 204A, 204B, & 204C.

As noted previously, the first arrow 111A of FIG. 2A denotes that the first and second PLL clocks 204A, 204B and the first and second TX/RX blocks 202A, 202B, by using the clock signals of the second PLL clock 204B, support the single communication link 103A of FIGS. 1A & 2A which may operate according to the PCIe standard described above. Similarly, second arrow 111B of FIG. 2A denotes that the second and third PLL clocks 204B, 204C and the third and fourth TX/RX blocks 202C, 202D, by using the clock signals of the second clock 204B, also support the single communication link 103A of FIGS. 1A & 2A which may operate according to the PCIe standard described above.

The inventive bus system 101 is not limited to the three low power modes illustrated in FIG. 2A. That is, the inventive bus system 101 (FIG. 1A) that supports the single communication link 103A of FIG. 2A may determine the low power mode for each clock 204 (i.e. first, second, or third mode). The bus system 101 may determine the low power mode for each clock 204 based on the locations and number of the end points 105, 107 (see FIG. 1A) being supported during the low power mode in addition to the number of communication links 103 being supported by the bus system 101.

For example, FIG. 2B described in more detail below illustrates another exemplary embodiment for the bus system 101 of FIG. 1A. FIG. 2A illustrates PLL clocks 204 which have a different low power mode configuration compared to FIG. 2A, where one communication link 103A is supported between end points 105, 107.

Referring now to FIG. 2B, this figure is a functional block diagram illustrating the details for the single row layout of FIG. 1A, according to different exemplary embodiment relative to FIG. 2A. This embodiment of FIG. 2B may support a single communication link 103A′ that may operate according to the peripheral component interconnect express (“PCIe”) serial computer expansion bus standard. The single row layout of FIG. 2B is very similar to the single row layout 101A of FIG. 2A. Therefore, only the differences between these two figures will be described below.

When the PCS control module 201 receives a signal that one or more of its endpoints 105, 107 (see FIG. 1A) may enter into a low power mode, the PCS control module 201 may send signals to the first PLL clock 204A, the second PLL clock 204B, and the third PLL clock 204C to put them into the second low power mode. As noted previously, in this second low power mode, a PLL clock 204 may function as a clock driver, while its voltage controlled oscillator (VCO) is turned off as well as any clock drivers and slew control which may also be turned off.

In other words, the clock 204 in the second low power mode is used as a re-driver or extension of the clock network instead of functioning as a “regular” or “standard” clock. This means the PLL clock 204 in the second low power mode does not originate or generate any clock signals but instead relays or transmits clock signals that it receives from another clock, which originates the clock signals.

The PCS control module 201 may also send a signal to the fourth PLL clock 204D to put this clock into the third low power mode described previously. In the third low power mode, the fourth clock 204D may function as the primary clock for the single communication link 101A that will be active during the low power mode.

Meanwhile, as noted above, the other three PLL clocks 204A, 204B, 204C of FIG. 2B operating in the second low power mode may function as clock drivers, where these three PLL clocks 204 will relay/re-transmit the clock signals produced by the fourth PLL clock 204D to support the single communication link 103A'. Single arrow 111 of FIG. 2B represents the single clock signal originating from the fourth PLL clock 204D and which is relayed/re-transmitted by the third, second, and first PLL clocks 204C, 204B, and 204A.

Thus, single arrow 111 of FIG. 2B denotes that the first through fourth PLL clocks 204A, 204B, 204C, 204D and the first through fourth TX/RX blocks 202A, 202B, 202C, 202D using the clock signal of the fourth PLL clock 204D establish/support the first communication link 103A′ of FIGS. 1A & 2B which may operate according to the PCIe standard described above. As noted previously, single arrow 111 indicates that the fourth PLL clock 204D is the primary/sole/single clock for the communication link 103A′. According to the exemplary embodiment of FIG. 2B, there are no clocks 204 which are in the first low power mode described previously, where all or almost all power to a clock 204 is turned-off such that the clock 204 does not support any communications while in this first low power mode.

Comparing the low power mode configuration of FIG. 2B to FIG. 2A, one PLL clock 204D in FIG. 2A is in the first low power mode (i.e. turned off), while there are no clocks 204 in FIG. 2B in this first low power mode. Similarly, two clocks 204A, 204B of FIG. 2A are in the second low power mode, while three clocks 204A, 204B, & 204C of FIG. 2B are in the second low power mode.

Thus, the low power mode configuration of FIG. 2A may conserve more power (i.e. consume less electrical energy) compared to the low power mode configuration of FIG. 2B. Meanwhile, both low power mode configurations of FIGS. 2A & 2B may establish a single communication link 103A supported by clocks 204A-204D and TX/RX lanes 202A-202D, which use the clock signals of only one clock (i.e. 204B of FIG. 2A or 204D of FIG. 2B), and which may operate according to the PCIe standard. As noted previously, the PCIe standard may use different Gen speeds as needed.

The inventive bus system 101 is not limited to the various low power modes of the PLL clocks 204 illustrated in FIGS. 2A-2B. That is, the inventive bus system 101 of FIGS. 2A-2B (via PCS control module 201) may determine the low power mode for each clock 204 (i.e. first, second, or third mode) based on the locations and number of the end points 105, 107 (see FIG. 1A) being supported during a low power mode in addition to the number of communication links 103 (i.e. only one link for FIGS. 2A-2B) being supported by the bus system 101.

Referring now to FIG. 2C, this figure is a functional block diagram illustrating the details for the two row layout of FIG. 1B according to one exemplary embodiment. This embodiment of FIG. 2C may support a single communication link 103B that may operate according to the peripheral component interconnect express (“PCIe”) serial computer expansion bus standard. The two row layout of FIG. 2C is very similar to the single row layout of FIG. 2A. Therefore, only the differences between these two figures will be described below.

According to this exemplary embodiment of FIG. 2C, when the PCS control module 201 receives a signal that one or more of its end points 105, 107 (see FIG. 1B) may be entering into a low power mode and that only one communication link is needed during this low power mode (LPM), then the PCS control module 201 may send a signal to the first PLL clock 204A to place it into the first low power mode described previously.

In this first low power mode, the first PLL clock 204A of FIG. 2C may not receive any power or a negligible power amount such that it does not support any communication signals and/or does not operate. The first PLL clock 204D of FIG. 2C has been shaded with gray shading to indicate that it is in the first low power mode as described previously.

The PCS control module 201 of FIG. 2C may send a signal to the second PLL clock 204B and third PLL clock 204C to put these two clocks 204 into the second low power mode described previously. In this second low power mode, each clock 204B, 204C may function as clock driver and will not have its voltage controlled oscillator (VCO) powered (i.e. turned on). The second PLL clock 204B and the third PLL clock 204C of FIG. 2C have been illustrated with vertical lines to denote this second low power mode.

The PCS control module 201 may then send a signal to the fourth PLL clock 204D of FIG. 2C to place it into the third low power mode described above. In the third low power mode, this fourth PLL clock 204D functions as the primary/sole/single clock for the single communications link 103B of FIG. 2C during the low power mode. The fourth PLL clock 204D of FIG. 2C has not been provided with any shading (i.e. it is clear compared to clocks 204A, 204B, & 204C) to denote that it is operating in the third low power mode described above.

Thus, first arrow 111A of the first row in FIG. 2C denotes that the clock signal from the fourth PLL clock 204D is used by the first and second TX/RX blocks 202A, 202B and second PLL clock 204B to support the single communication link 103B of FIGS. 1B & 2C, which may operate according to the PCIe standard described above. Similarly, second arrow 111B of the second row in FIG. 2C denotes that the clock signal from the fourth PLL clock 204D is used by the third and fourth TX/RX blocks 202C, 202D and third PLL clock 204C to support the single communication link 103B of FIGS. 1B & 2C, which may operate according to the PCIe standard described above.

Referring now to FIG. 3A is a functional block diagram illustrating the details for the single row layout of FIG. 1C in which two communication links 103A1, 103A2 are supplied between end points of the bus system 101 according to one exemplary embodiment. This embodiment of FIG. 3A and FIG. 1C may support two communication links 103A1, 103A2 that may operate according to the peripheral component interconnect express (“PCIe”) serial computer expansion bus standard.

The single row layout 101 of FIG. 3A that supports two communication links is very similar to the single row layout 101A of FIG. 2A which supports a single communication link. Therefore, only the differences between these two figures will be described below.

According to this exemplary embodiment of FIG. 3A, when the PCS control module 201 receives a signal that one or more of its three end points 105, 107, 109 (see FIG. 1C) may be entering into a low power mode and that two communication links are needed during this low power mode (LPM), then the PCS control module 201 may send a signal to the second and fourth PLL clocks 204B, 204D to place them into the first low power mode described previously.

In this first low power mode, the second PLL clock 204B and fourth clock 204D of FIG. 3A may not receive any power or a negligible power amount such that they do not support any communication signals and/or do not operate. The second PLL clock 204B and fourth PLL clock 204D of FIG. 3A have been shaded with gray shading to indicate that they are in the first low power mode as described previously.

The PCS control module 201 may then send a signal to the first PLL clock 204A and third PLL clock 204C of FIG. 3A to place them both into the third low power mode described above. In the third low power mode, the first PLL clock 204A and second PLL clock 204D function as the primary or sole clock for each of the two communications links 103A1, 103A2 of FIG. 2C during the low power mode.

That is, arrows 111A1 and 111A2 represent that the first PLL clock 204A of FIG. 3A functions as the primary clock for the first communication link 103A1 that may operate according to the PCIe standard. Similarly, arrows 111B1 and 111B2 represent that the third PLL clock 204C of FIG. 3A may function as the primary clock for the second communication link 103A2 that may operate according to the PCIe standard. The first PLL clock 204A and third PLL clock 204C of FIG. 3A have not been provided with any shading (i.e. they are clear compared to clocks 204B & 204D) to denote that they are operating in the third low power mode described above.

Thus, arrows 111A1 & 111A2 of FIG. 3A denote that the first PLL clock 204A using its clock signals for first and second TX/RX blocks 202A, 202B support the first communication link 103A1 of FIGS. 1C & 3A which may operate according to the PCIe standard described above. Similarly, arrows 111B1, 111B2 of FIG. 3A denote that the third PLL clock 204C using its clock signals for the third and fourth TX/RX blocks 202C, 202D support the second communication link 103A2 of FIGS. 1D & 3A which may operate according to the PCIe standard described above.

Referring now to FIG. 3B, this figure is a functional block diagram illustrating the details for the two row layout of FIG. 1D that supports two communication links 103B1, 103B2 according to one exemplary embodiment. This embodiment of FIG. 3B and FIG. 1D may support two communication links 103B1, 103B2 that may operate according to the peripheral component interconnect express (“PCIe”) serial computer expansion bus standard.

The two row layout of FIG. 3B is very similar to the two row layout for the single communication link 103B of FIG. 2C. Therefore, only the differences between these two figures will be described below.

According to this exemplary embodiment of FIG. 3B, when the PCS control module 201 receives a signal that one or more of its end points 105, 107, 109 (see FIG. 1D) may be entering into a low power mode and that two communication links 103B1, 103B2 are needed during this low power mode (LPM), then the PCS control module 201 may send a signal to the first PLL clock 204A and to the fourth PLL clock 204D to place them into the third low power mode described previously.

In the third low power mode, the first PLL clock 204A and fourth PLL clock 204D may function as the primary or sole clock for the respective two communication links 103B1, 103B2 of FIG. 3B during the low power mode. The first PLL clock 204A and fourth PLL clock of FIG. 3B have not been provided with any shading (i.e. they are clear compared to clocks 204B & 204C) to denote that they are operating in the third low power mode described above.

The PCS control module 201 of FIG. 3B may send a signal to the second PLL clock 204B and third PLL clock 204C to put these two clocks 204 into the second low power mode described previously. In this second low power mode, each clock 204B, 204C of FIG. 3B may function as clock driver (i.e. transmitter/repeater) and will not have its voltage controlled oscillator (VCO) powered (i.e. turned on). The second PLL clock 204B and the third PLL clock 204C of FIG. 3B have been illustrated with vertical lines to denote this second low power mode.

Thus, first arrow 111A of the first row in FIG. 3B denotes that the first and second PLL clocks 204A, 204B and the first and second TX/RX blocks 202A, 202B, by using the clocks signals from the first PLL clock 204A, support the first communication link 103B1 of FIGS. 1D & 3B which may operate according to the PCIe standard described above. Similarly, second arrow 111B of the second row of FIG. 3B denotes that the third and fourth PLL clocks 204C, 204D and the third and fourth TX/RX blocks 202A, 202B,, by using the clocks signals from the fourth PLL clock 204D, may support the second communication link 103B2 of FIGS. 1D & 3B which may operate according to the PCIe standard described above.

Referring now to FIG. 3C, this figure is a functional block diagram illustrating the details for the two row layout of FIG. 1D that supports two communication links 103B1, 103B2 according to an alternative exemplary embodiment compared to FIG. 3B. This embodiment of FIG. 3C and FIG. 1D may support two communication links 103B1, 103B2 that may operate according to the peripheral component interconnect express (“PCIe”) serial computer expansion bus standard. The two row layout of FIG. 3C is very similar to the two row layout of FIG. 3B. Therefore, only the differences between these two figures will be described below.

According to this exemplary embodiment of FIG. 3C, when the PCS control module 201 receives a signal that one or more of its end points 105, 107, 109 (see FIG. 1D) may be entering into a low power mode and that two communication links 103B1, 103B2 are needed during this low power mode (LPM), then the PCS control module 201 may send a signal to the first PLL clock 204A to place it into the first power mode described above.

In this first low power mode, the first PLL clock 204A of FIG. 3C may not receive any power or a negligible power amount such that it does not support any communication signals and/or do not operate. The first PLL clock 204A of FIG. 3C has been shaded with gray shading to indicate that it is in the first low power mode as described previously.

The PCS control module 201 may send a signal to the second PLL clock 204B and fourth PLL clock 204D to place them into the third low power mode described previously. In the third low power mode, the second PLL clock 204B and fourth PLL clock 204D may function as the primary or sole clock for the respective two communication links 103B1, 103B2 of FIG. 3C during the low power mode. The second PLL clock 204B and fourth PLL clock 204D of FIG. 3C have not been provided with any shading (i.e. they are clear compared to clocks 204A & 204C) to denote that they are operating in the third low power mode described above.

The PCS control module 201 of FIG. 3C may send a signal to the third PLL clock 204C to put this clock into the second low power mode described previously. In this second low power mode, the third PLL clock 204B may function as a clock driver (i.e. transmitter/repeater) and will not have its voltage controlled oscillator (VCO) powered (i.e. turned on). The third PLL clock 204C of FIG. 3C has been illustrated with vertical lines to denote this second low power mode.

Thus, the first two arrows 111A1, 111A2 of the first row in FIG. 3C denote that the second PLL clock 204B and the first and second TX/RX blocks 202A, 202B, by using the clock signals from the second PLL clock 204B, may support the first communication link 103B1 of FIGS. 1D & 3C which may operate according to the PCIe standard described above. Similarly, single arrow 111B of the second row of FIG. 3C denotes that the third and fourth PLL clocks 204C, 204D and the third and fourth TX/RX blocks 202A, 202B, by using the clock signals from the fourth PLL clock 204D, may support the second communication link 103B2 of FIGS. 1D & 3C which may operate according to the PCIe standard described above.

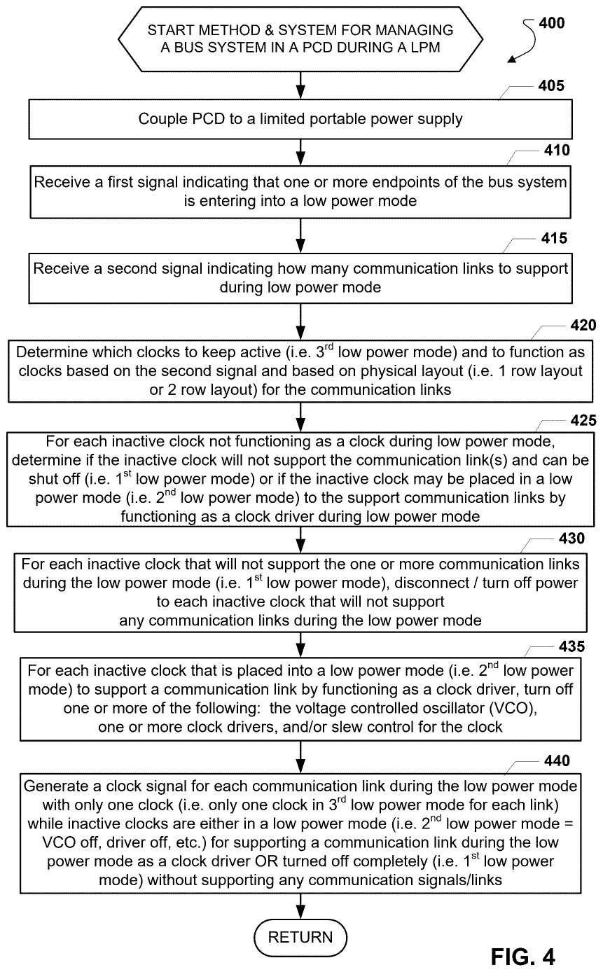

Referring now to FIG. 4, this figure illustrates a logical flow chart of a method 400 for managing a communication bus system 101 in a portable computing device (PCD) 500 (see FIG. 5) during a low power mode (LPM). Block 405 is the first block of method 400.

As indicated by block 405, the method 400 may include coupling a PCD (see FIG. 5) to a limited portable power supply 574. As noted above, the limited portable power supply 574 may comprise one or more rechargeable batteries that provide direct current (“DC”) power. However, the limited portable power supply 574 may also include capacitors, and/or rechargeable batteries combined with capacitors as understood by one of ordinary skill in the art. The PCD 500 and its technical details are further described below in connection with FIG. 5.

As shown by block 410 of FIG. 4, the method 400 may further include receiving a first signal indicating that one or more endpoints 105, 107, 109 of the bus system 101 (See FIGS. 1A-1D) is/are entering into a low power mode. The end points 105, 107, 109 may comprise one or more different hardware elements, such as, but not limited to, a central processing unit 105, a graphical processing unit 107, a neural processing unit 109, memory devices 528, 530, etc. etc. The endpoints 105, 107, or 109 may originate this first signal of block 410.

Subsequently, as indicated by block 415, the method 400 may further include receiving a second signal indicating how many communication links 103A, 103B to support while the one or more endpoints 105, 107, 109 enter into a low power mode. Such communication links 103A, 103B may operate according to the PCIe standard described above. This second signal may be generated by one or more of the endpoints 105, 107, 109 and/or the physical coding sublayer (PCS) control module 201.

After block 415, as indicated by block 420, the method 400 may include determining which clocks 204 to keep active and to function as clocks 204 based on the second signal and based on the physical layout of the SoC/PCB 102 (i.e. 1 row layout or 2 row layout) for the communication links 103A, 103B. This block 415 corresponds to the third low power mode described above in which a single or primary clock 204 is identified to support a single communication link 103A or 103B. This determination of which clocks 204 to keep active may be performed by the physical coding sublayer (PCS) control module 201.

Next, as indicated by block 425, the method 400 may include determining if an inactive clock 204 will not support the communication link(s) 103A, 103B (not functioning as a clock during the low power mode) and can be shut off, or if the inactive clock 204 may be placed in a low power mode to the support communication links 103A, 103B by functioning as a clock driver during the low power mode. This block 425 corresponds with the first and second low power modes described above. In this block 424, it is determined if a clock 204 should be placed in the first low power mode (i.e. completely off) or in the second low power mode (i.e. function as a clock driver). The PCS control module 201 of FIGS. 2A-4B may make this determination of whether to place a clock 204 in the first low power mode or second low power mode.

Subsequently, as indicated by block 430, the method 400 may include removing or significantly reducing power to each inactive clock 204 that will not support the one or more communication links 103A, 103B during the low power mode. This block 430 corresponds with the first low power mode described previously. For the first low power mode, power may shut be shut off (or power may be reduced significantly) to a clock 204 such that it does not support any communication signals and/or does not operate to support an active communication link 103A, 103B. This shutting off of power or reducing power to a clock 204 may be performed by the PCS control module 201.

Next, as provided by block 435 of FIG. 4, the method 400 may include turning off/shutting off at least one of the following for each inactive clock 204 that is placed in a low power mode while also supporting a communication link 103A, 103B (i.e. the second low power mode described previously): the voltage controlled oscillator (VCO) for the clock 204; one or more clock drivers; and/or slew control for the clock 204. This activation of the second low power mode may be performed by the PCS control module 201.

Subsequently, as indicated by block 440, the method 400 may also include generating a clock signal for each communication link 103A, 103B during the low power mode with only one clock 204 (i.e. only one clock 204 operating in the third low power mode described previously). Meanwhile, the inactive clocks 204 in the second low power mode may support each communication link 103A, 103B by functioning as clock drivers for the single clock operating in the third low power mode.

And during block 440, the inactive clocks 204 in the first low power mode may be shut off and/or provided with such reduced power that each clock 204 in the first low power mode does not support any communication link 103A, 103B but conserves power for the limited portable power supply 574 (see FIGS. 1A-1D and FIG. 5).

Firmware or software may be stored in any of the memories (i.e. SRAM 528, DRAM 530, etc. of FIG. 5), or may be stored in a local memory directly accessible by processor hardware (i.e. local cache) on which the software or firmware executes. Execution of such firmware or software that may comprise the PCS control module 201 may control aspects of any of the above-described methods or configure aspects of any of the above-described systems.

Any such memory or other non-transitory storage medium having firmware or software stored therein in computer-readable form for execution by processor hardware may be an example of a “computer-readable medium,” as the term is understood in the patent lexicon.

It should be noted that the process represented by the flow diagram shown in FIG. 4 described above may be modified or augmented in a number of ways within the scope of the present disclosure. That is, certain blocks/steps in the process/method 400 described above naturally precede others for the bus system 101 to function as described.

However, the method 400 and bus system 101 are not limited to the order of the steps described if such order or sequence does not alter the functionality of the bus system 101 and method 400. That is, it is recognized that some steps may be performed before, after, or in parallel with (substantially simultaneously with) other blocks/steps without departing from the scope of this disclosure. In some instances, certain blocks/steps may be omitted or not performed without departing from this disclosure as understood by one of ordinary skill in the art.

Further, words such as “thereafter”, “then”, “next”, etc. are not intended to limit the order of the blocks/steps illustrated in method 400 of FIG. 4. These words are simply used to guide the reader through the description of the exemplary method 400 with the understanding that the sequence of blocks/steps may be adjusted depending upon a particular application of the method 400 and/or bus system 101.

By utilizing the method 400 and system 101, complicated clock drivers and other clock-quality circuits can be re-used within a PLL to extend the reach of the PLL clocks, as understood by one of ordinary skill in the art.

Referring now to FIG. 5, this figure illustrates details of an exemplary portable computing device (PCD) 500 that houses the limited portable power supply 574 and SoC/PCB 102 illustrated in FIG. 1A and which can support low power modes of its communication buses 101 positioned on/within each SoC/PCB 102. The PCD 500 may further include the PCS control module 201 that determines which of the three modes each PLL clock 204 (see FIG. 2) will be placed into during a low power mode (LPM).

As noted above, according to one exemplary embodiment, the PCS control module 201 may comprise software executed by CPU 105. However, the PCS control module 201 may comprise hardware (H/W), firmware, software, or any combination thereof.

The PCD 500 may be, for example, a laptop or palmtop computer, cellular telephone or smartphone, personal digital assistant (PDA), navigation device, smartbook, portable game console, satellite telephone, automotive device, Internet-of-Things (IoT) device, etc.

The PCD 500 may include the SoC/PCB 102 of FIG. 1. The SoC 102 may include a CPU 105, a GPU 107, a digital signal processor (DSP) 507, an analog signal processor 508, a RF transceiver that includes a modem/modem subsystem 554. The CPU 105 may include one or more CPU cores, such as a first CPU core 105A, a second CPU core 105B, etc., through an Nth CPU core 105N.

A display controller 510 and a touch-screen controller 512 may be coupled to the CPU 105. A touchscreen display 514 external to the SoC 502 may be coupled to the display controller 510 and the touch-screen controller 512. The PCD 500 may further include a video decoder 516 coupled to the CPU 105. A video amplifier 518 may be coupled to the video decoder 516 and the touchscreen display 514.

A video port 520 may be coupled to the video amplifier 518. A universal serial bus (USB) controller 522 may also be coupled to CPU 105, and a USB port 524 may be coupled to the USB controller 522. A subscriber identity module (SIM) card 526 may also be coupled to the CPU 105.

Each of the couplings/connections 202 between elements shown in FIG. 5, such as, but not limited to: between the video port 520 & video amplifier 518; between the display 514 and the touch screen controller 512; between the display 514 and the video amplifier 518; between the CPU 105 and the touch screen controller 512; between the CPU 105 and the video decoder 516; all of these couplings/connections may comprise the TX/RX blocks 202 described previously and illustrated in FIGS. 2A-4B. Between each TX/RX block 202, there may be one or more PLL clocks 204 described above and shown in FIGS. 2A-4B.

Meanwhile, the CPU 105 may be coupled to one or more memories, with which the CPU 105 or other processors may initiate memory transactions. The one or more memories may include both volatile and non-volatile memories. Examples of volatile memories include static random access memory (SRAM) 528 and dynamic random access memory (DRAM) 530. The DRAM 530 may include a DRAM memory controller 532. Such memories 528, 530 may be internal to the SoC 502, as in the case of the DRAM 530, or external to the SoC 502 (not shown).

A stereo audio CODEC 534 may be coupled to the analog signal processor 508. Further, an audio amplifier 536 may be coupled to the stereo audio CODEC 534. First and second stereo speakers 538 and 540, respectively, may be coupled to the audio amplifier 536. In addition, a microphone amplifier 542 may be coupled to the stereo audio CODEC 534, and a microphone 544 may be coupled to the microphone amplifier 542.

A frequency modulation (FM) radio tuner 546 may be coupled to the stereo audio CODEC 534. An FM antenna 548 may be coupled to the FM radio tuner 546. Further, stereo headphones 550 may be coupled to the stereo audio CODEC 534. Other devices that may be coupled to the CPU 105 include one or more digital (e.g., CCD or CMOS) cameras 552.

The RF transceiver or modem subsystem 554 may be coupled to the analog signal processor 508 and the CPU 105. An RF switch 556 may be coupled to the modem subsystem 554 and an RF antenna 558. In addition, a keypad 560, a mono headset with a microphone 562, and a vibrator device 564 may be coupled to the analog signal processor 508.

The SoC 502 may have one or more internal or on-chip thermal sensors 570A and may be coupled to one or more external or off-chip thermal sensors 570B. An analog-to-digital converter controller 572 may convert voltage drops produced by the thermal sensors 570A and 570B to digital signals.

A power supply 574 and a power management integrated circuit (PMIC) 576 may supply power to the SoC 502. The power supply 574 may comprise a rechargeable battery or a capacitor, or any combination thereof.

Implementation examples are described in the following numbered clauses:
1. A method for managing a bus system within a portable computing device (PCD) during a low power mode, comprising:
powering the bus system with a limited portable power supply;
receiving a first signal indicating that one or more endpoints of the bus system are entering into a low power mode;
receiving a second signal indicating how many communication links that will be supported by the bus system during the low power mode; and
determining if a clock coupled to a transmission line of the bus system should function as a clock during the low power mode or if the clock should function as a clock driver during the low power mode.
2. The method of clause 1, wherein when a clock is determined to function as a clock driver, then turning off at least one of a voltage controlled oscillator, a clock driver, and slew control, for the clock.
3. The method of clauses 1-2, wherein the bus system operates according to peripheral component interconnect express (“PCIe”) standard.
4. The method of clauses 1-3, further comprising determining if power to a clock coupled to a transmission line should be significantly reduced where the clock does not support any communication signals propagated along the transmission line.
5. The method of clauses 1-4, further comprising determining if a clock coupled to a transmission line should be a single clock to establish a communication link.
6. The method of clauses 1-5, wherein the clock comprises a phased locked loop clock.
7. The method of clauses 1-6, wherein the clock supports a peripheral component interconnect express (“PCIe”) standard.
8. The method of clauses 1-7, wherein an endpoint comprises a processor.
9. The method of clauses 1-8, wherein the PCD comprises at least one of: a laptop or palmtop computer, a cellular telephone or smartphone, a personal digital assistant (PDA), a navigation device, a smartbook computer, a portable game console, a satellite telephone, an automotive device, and an Internet-of-Things (IoT) device.
10. A system for managing a bus system within a portable computing device (PCD) during a low power mode, comprising:
a limited portable power supply for powering the bus system; and
a physical coding sublayer (PCS) control module receiving a first signal indicating that one or more endpoints of the bus system are entering into a low power mode; the PCS control module receiving a second signal indicating how many communication links that will be supported by the bus system during the low power mode; the PCS control module determining if a clock coupled to a transmission line of the bus system should function as a clock during the low power mode or if the clock should function as a clock driver during the low power mode.
11. The system of clause 10, wherein when a clock is determined to function as a clock driver, then the PCS control module turns off at least one of: a voltage controlled oscillator, a clock driver, and slew control, for the clock.
12. The system of clauses 10-11, wherein the bus system operates according to peripheral component interconnect express (“PCIe”) standard.
13. The system of clauses 10-12, wherein the PCS control module determines if power to a clock coupled to a transmission line should be significantly reduced where the clock does not support any communication signals propagated along the transmission line.
14. The system of clauses 10-13, wherein the PCS control module determines if a clock coupled to a transmission line should be a single clock to establish a communication link.
15. The system of clauses 10-14, wherein the PCS control module determines if a clock coupled to a transmission line should be a single clock to establish a communication link.
16. The system of clauses 10-15, wherein the clock comprises a phased locked loop clock.
17. A computer program product comprising a non-transitory computer usable medium having a computer readable program code embodied therein, said computer readable program code adapted to be executed to implement a method for managing a bus system, said method comprising:
powering the bus system with a limited portable power supply;
receiving a first signal indicating that one or more endpoints of the bus system are entering into a low power mode;
receiving a second signal indicating how many communication links that will be supported by the bus system during the low power mode; and
determining if a clock coupled to a transmission line of the bus system should function as a clock during the low power mode or if the clock should function as a clock driver during the low power mode.
18. The computer program product of clause 17, wherein when a clock is determined to function as a clock driver, then turning off at least one of a voltage controlled oscillator, a clock driver, and slew control, for the clock.
19. The computer program product of clauses 17-18, wherein the bus system operates according to peripheral component interconnect express (“PCIe”) standard.
20. The computer program product of clauses 17-19, wherein the program code implementing the method further comprises: determining if power to a clock coupled to a transmission line should be significantly reduced where the clock does not support any communication signals propagated along the transmission line.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for managing a bus system within a portable computing device (PCD) during a low power mode, comprising:
receiving a first signal indicating that one or more endpoints of the bus system are entering into a low power mode;
receiving a second signal indicating how many communication links that will be supported by the bus system during the low power mode; and
determining if a clock coupled to a transmission line of the bus system should function as a clock during the low power mode or if the clock should function as a clock driver during the low power mode.

2. The method of claim 1, wherein when a clock is determined to function as a clock driver, then turning off at least one of a voltage controlled oscillator, a clock driver, and slew control, for the clock.

3. The method of claim 1, wherein the bus system operates according to peripheral component interconnect express (“PCIe”) standard.

4. The method of claim 1, further comprising determining if power to a clock coupled to a transmission line should be significantly reduced where the clock does not support any communication signals propagated along the transmission line.

5. The method of claim 1, further comprising determining if a clock coupled to a transmission line should be a single clock to establish a communication link.

6. The method of claim 1, wherein the clock comprises a phased locked loop clock.

7. The method of claim 6, wherein the clock supports a peripheral component interconnect express (“PCIe”) standard.

8. The method of claim 1, further comprising: powering the bus system with a limited portable power supply.

9. The method of claim 1, wherein the PCD comprises at least one of: a laptop or palmtop computer, a cellular telephone or smartphone, a personal digital assistant (PDA), a navigation device, a smartbook computer, a portable game console, a satellite telephone, an automotive device, and an Internet-of-Things (IoT) device.

10. A system for managing a bus system within a portable computing device (PCD) during a low power mode, comprising:
a physical coding sublayer (PCS) control module receiving a first signal indicating that one or more endpoints of the bus system are entering into a low power mode; the PCS control module receiving a second signal indicating how many communication links that will be supported by the bus system during the low power mode; and the PCS control module determining if a clock coupled to a transmission line of the bus system should function as a clock during the low power mode or if the clock should function as a clock driver during the low power mode.

11. The system of claim 10, wherein when a clock is determined to function as a clock driver, then the PCS control module turns off at least one of: a voltage controlled oscillator, a clock driver, and slew control, for the clock.

12. The system of claim 10, wherein the bus system operates according to peripheral component interconnect express (“PCIe”) standard.

13. The system of claim 10, wherein the PCS control module determines if power to a clock coupled to a transmission line should be significantly reduced where the clock does not support any communication signals propagated along the transmission line.

14. The system of claim 10, wherein the PCS control module determines if a clock coupled to a transmission line should be a single clock to establish a communication link.

15. The system of claim 10, wherein the PCS control module determines if a clock coupled to a transmission line should be a single clock to establish a communication link.

16. The system of claim 10, further comprising a limited portable power supply for powering the bus system.

17. A computer program product comprising a non-transitory computer usable medium having a computer readable program code embodied therein, said computer readable program code adapted to be executed to implement a method for managing a bus system, said method comprising:
receiving a first signal indicating that one or more endpoints of the bus system are entering into a low power mode;
receiving a second signal indicating how many communication links that will be supported by the bus system during the low power mode; and
determining if a clock coupled to a transmission line of the bus system should function as a clock during the low power mode or if the clock should function as a clock driver during the low power mode.

18. The computer program product of claim 17, wherein when a clock is determined to function as a clock driver, then turning off at least one of a voltage controlled oscillator, a clock driver, and slew control, for the clock.

19. The computer program product of claim 17, wherein the bus system operates according to peripheral component interconnect express (“PCIe”) standard.

20. The computer program product of claim 17, wherein the program code implementing the method further comprises: determining if power to a clock coupled to a transmission line should be significantly reduced where the clock does not support any communication signals propagated along the transmission line.
